(19) United States
(12) Patent Application Publication
(10) Pub. No.: US 2024/0416427 A1
(43) Pub. Date: Dec. 19, 2024

(54) CERMET TOOL AND CUTTING TOOL

(71) Applicant: KYOCERA CORPORATION, Kyoto-shi, Kyoto (JP)

(72) Inventor: Ryou OGINO, Satsumasendai-shi, Kagoshima (JP)

(21) Appl. No.: 18/704,932

(22) PCT Filed: Oct. 17, 2022
(86) PCT No.: PCT/JP2022/038561

§ 371 Date: Apr. 26, 2024

(30) Foreign Application Priority Data
Nov. 2, 2021 (JP) 2021-179606

(51) Int. Cl. B23B 27/14

(52) U.S. Cl. CPC B23B 27/148; B22F 2301/15; B22F 2302/10

(57) ABSTRACT

A cermet tool according to the present disclosure has a base made of a cermet sintered body, the cermet sintered body containing a hard phase containing at least a carbonitride of Ti and a binder phase containing Co and/or Ni. The cermet tool according to an aspect of the present disclosure contains the hard phase and the binder phase, further contains Cr and W, and has a strength I₈₀₀ at 800° C. of 1400 MPa or greater, and a ratio of the strength Isco to a strength L at room temperature, that is, I₈₀₀/Iᵣ, of 0.9 or greater.

### RELATED APPLICATIONS

The present application is a National Phase of International Application No. PCT/JP2022/038561 filed Oct. 17, 2022, which claims priority to Japanese Application No. 2021-179606, filed Nov. 2, 2021.

### TECHNICAL FIELD

The present disclosure relates to a cermet tool and a cutting tool.

### BACKGROUND OF INVENTION

Cermet, which is mainly composed of titanium (Ti), is widely used as a base material for cutting tools, wear-resistant members, sliding members, and the like that require wear resistance, slidability, and chipping resistance.

### CITATION LIST

### Patent Literature

Patent Document 1: JP 3099834 B

### SUMMARY

### Problem to be Solved

A cermet tool according to an aspect of the present disclosure is a cermet tool having a base made of a cermet sintered body, the cermet sintered body containing a hard phase containing at least a carbonitride of Ti and a binder phase containing Co and/or Ni. The cermet tool according to an aspect of the present disclosure contains the hard phase and the binder phase, further contains Cr and W, and has a strength I₈₀₀ at 800° C. of 1400 MPa or greater, and a ratio of the strength I₈₀₀ to a strength Iᵣ at room temperature, that is, I₈₀₀/Iᵣ, of 0.9 or greater.

### BRIEF DESCRIPTION OF THE DRAWINGS

FIG. 1 is a perspective view illustrating an example of a cermet tool according to an embodiment.

FIG. 2 is a side cross-sectional view illustrating an example of the cermet tool according to the embodiment.

FIG. 3 is a schematic view for explaining a mechanism of solid solution of W in the binder phase into the hard phase in a cermet according to a reference example containing no Cr in the hard phase and the binder phase.

FIG. 4 is a schematic view for explaining a mechanism of solid solution of W in the binder phase into the hard phase in the cermet according to the reference example containing no Cr in the hard phase and the binder phase.

FIG. 5 is a schematic view for explaining a mechanism by which solid solution of W in the binder phase into the hard phase in the base of the cermet tool according to the embodiment is suppressed.

FIG. 6 is a schematic view for explaining a mechanism by which solid solution of W in the binder phase into the hard phase in the base of the cermet tool according to the embodiment is suppressed.

FIG. 7 is a front view illustrating an example of a cutting tool according to the embodiment.

FIG. 8 is a table presenting blending amounts of various raw materials in Samples No. 1 to No. 10.

FIG. 9 is a table summarizing the results of various tests on Samples No. 1 to No. 10.

### DESCRIPTION OF EMBODIMENTS

The following is a detailed description of embodiments of a cermet tool and a cutting tool according to the present disclosure (hereinafter referred to as “embodiments”) with reference to the drawings. Note that, the cermet tool and the cutting tool according to the present disclosure are not limited by the embodiments. Embodiments can be appropriately combined so as not to contradict each other in terms of processing content. In the following embodiments, the same portions are denoted by the same reference signs, and redundant explanations are omitted.

In the embodiments described below, expressions such as “constant”, “orthogonal”, “perpendicular”, and “parallel” may be used, but these expressions do not necessarily mean exactly “constant”, “orthogonal”, “perpendicular”, and “parallel”. That is, each of the expressions described above allows for deviations in, for example, manufacturing accuracy, installation accuracy, and the like.

Cermets are susceptible to thermal shock and are prone to fracture, and thus there is room for further improvement. The provision of a cermet tool and a cutting tool having high fracture resistance has been long-awaited.

### Cermet Tool

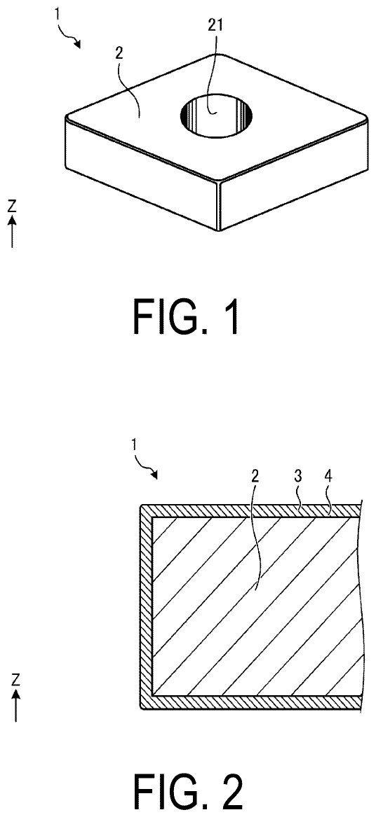

FIG. 1 is a perspective view illustrating an example of a cermet tool according to an embodiment. FIG. 2 is a side cross-sectional view illustrating an example of a cermet tool 1 according to the embodiment. As illustrated in FIG. 1 and FIG. 2, the cermet tool 1 according to the embodiment includes a base 2, a coating layer 3, and an intermediate layer 4.

### Base 2

The base 2 has, for example, a hexagonal shape in which the shape of an upper surface and a lower surface (surfaces intersecting the Z-axis illustrated in FIG. 1) is a parallelogram.

One corner of the base 2 functions as a cutting edge portion. The cutting edge portion has a first surface (for example, an upper surface) and a second surface (for example, a side surface) connected to the first surface. In the embodiment, the first surface functions as a “rake face” for scooping chips generated by cutting, and the second surface functions as a “flank face”. A cutting edge is located on at least a part of a ridge line where the first surface and the second surface intersect with each other, and the cermet tool 1 cuts a workpiece through application of the cutting edge to the workpiece.

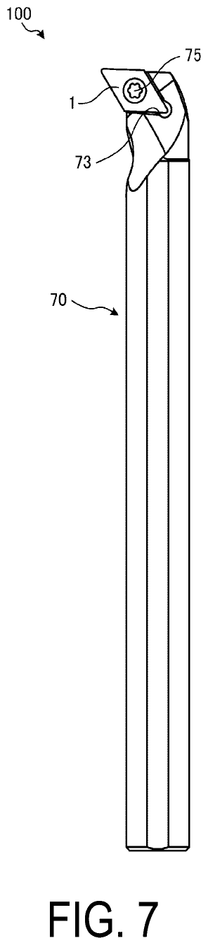

A through hole 21 that extends vertically through the base 2 may be located at a center portion of the base 2. In this case, a screw 75 for attaching the cermet tool 1 to a holder 70 described later is inserted into the through hole 21 (see FIG. 7).

The base 2 is made of a cermet sintered body. The cermet sintered body contains a hard phase and a binder phase. The hard phase contains at least a carbonitride of Ti (TiCN). The binder phase contains Co and/or Ni.

The base 2 further contains Cr and W in the hard phase and the binder phase. The cermet tool 1 according to the embodiment has a strength I₈₀₀ at 800° C. of 1400 MPa or greater, and a ratio of the strength I₈₀₀ to a strength Iᵣ at room temperature, that is, I₈₀₀/Iᵣ, of 0.9 or greater.

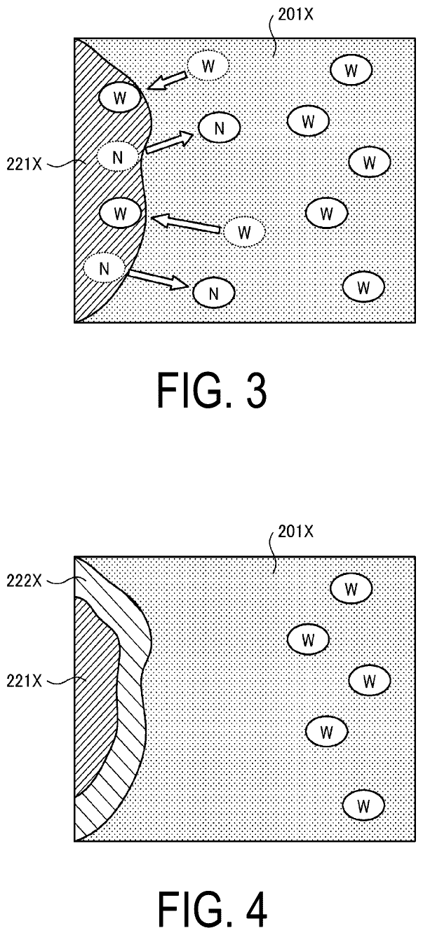

In the base 2 having such a configuration, the solid solution amount of W in the binder phase can be increased relatively as compared with the case where the hard phase and the binder phase do not contain Cr. This will be explained with reference to FIG. 3 to FIG. 6.

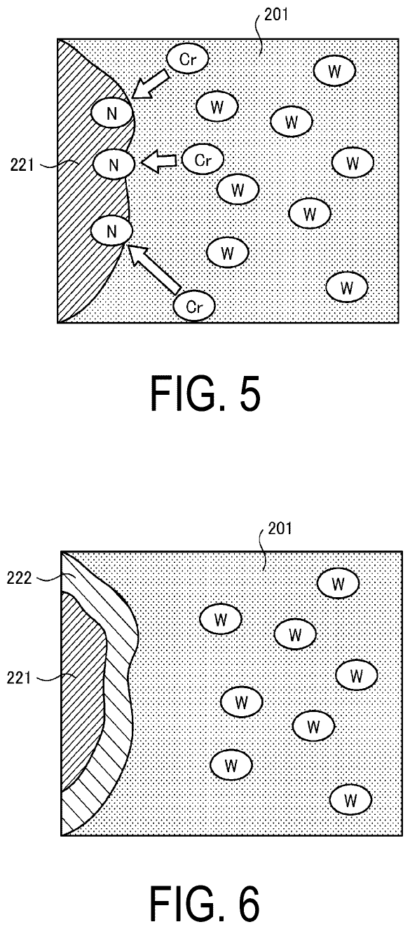

FIG. 3 and FIG. 4 are schematic views for explaining a mechanism of solid solution of W in the binder phase into the hard phase in a cermet according to a reference example containing no Cr in the hard phase and the binder phase. FIG. 5 and FIG. 6 are schematic views for explaining a mechanism by which solid solution of W in the binder phase into the hard phase in the base 2 of the cermet tool 1 according to the embodiment is suppressed.

During sintering of the cermet, N is desorbed from hard particles 221X such as TiCN, and W in a binder phase 201X enters the desorbed portion (see FIG. 3). As such, a solid solution 222X made of (Ti, M) CN (with M being a metal element that includes at least W) is formed in the periphery of the hard particles 221X (see FIG. 4). This reduces the amount of W in the binder phase.

In comparison, at the time of sintering the base 2 according to the embodiment, Cr contained in a binder phase 201 binds to N in hard particles 221 (see FIG. 5). As such, a solid solution 222 made of (Ti, M) CN (with M being a metal element that includes at least Cr) is formed in the periphery of the hard particles 221 (see FIG. 6).

In this way, in the base 2 according to the embodiment, the solid solution of W in the binder phase into the hard phase is suppressed, and thus the amount of W in the binder phase increases relatively as compared with that in the reference example. When the amount of W in the binder phase increases, the high-temperature hardness of the binder phase increases, and the high-temperature strength also increases. Therefore, the cermet tool 1 according to the embodiment can have improved fracture resistance.

The hard phase or the binder phase of the base 2 may further contain at least one metal element selected from the group consisting of Group 4A elements, Group 5A elements, and Group 6A elements (excluding Ti, Cr, and W) in the periodic table, as well as Si. For example, the base 2 may contain Zr, V, Nb, Ta, and Mo in addition to Ti, Cr, and W.

The content of Cr in the hard phase CrH may be 0.6 mass % or greater and less than 2.5 mass %.

When the content of Cr in the hard phase CrH is 0.6 mass % or greater, the amount of Cr dissolved in the hard phase is ensured. Thus, the amount of W dissolved in the hard phase decreases relatively, and accordingly the content of W in the binder phase increases.

Therefore, when the content of Cr in the hard phase CrH is 0.6 mass % or greater, the high-temperature strength improves easily. When the content of Cr in the hard phase CrH is less than 2.5 mass %, an excessive increase in the amount of the solid solution in the hard phase is easily avoided. Therefore, the entire hard phase containing the solid solution is less likely to be coarsened, and the high-temperature strength improves.

As such, the cermet tool 1 in which the content of Cr in the hard phase CrH is 0.6 mass % or greater and less than 2.5 mass % can have suitably increased high-temperature strength and suitably improved fracture resistance.

The content of W in the binder phase WB may be 0.8 mass % or greater and less than 1.8 mass %.

When the content of W in the binder phase WB is 0.8 mass % or greater, the content of W in the binder phase is ensured, and thus the high-temperature strength improves easily. In addition, when the content of W in the binder phase WB is less than 1.8 mass %, the binder phase is less likely to become brittle, and fracture resistance improves easily.

As such, the cermet tool 1 in which the content of W in the binder phase WB is 0.8 mass % or greater and less than 1.8 mass % can have suitably improved high-temperature strength and suitably improved fracture resistance.

The content of W in the hard phase WH may be 12.5 mass % or greater and 13.47 mass % or less.

When the content of W in the hard phase WH is 12.5 mass % or greater, the amount of the solid solution in the hard phase is stable and ensured. Therefore, the wear resistance of the hard phase improves, and the wear resistance of the cermet tool 1 on the whole improves.

When the content of W in the hard phase WH is 13.47 mass % or less, an excessive increase in the amount of the solid solution in the hard phase is easily avoided. Therefore, the fracture resistance of the hard phase improves, and the fracture resistance of the cermet tool 1 on the whole improves. That is, when the content of W in the hard phase WH is 12.5 mass % or greater and 13.47 mass % or less, the amount of the solid solution in the hard phase can be set to an appropriate amount, making it possible to achieve both wear resistance and fracture resistance in the hard phase.

The content of W in the hard phase WH may be higher than the content of W in the binder phase WB. The wear resistance of the cermet tool 1 on the whole is affected more by W in the hard phase than by W in the binder phase. Therefore, when WH is smaller than WB, the wear resistance of the cermet tool 1 on the whole can be improved without the content of W in the cermet tool 1 on the whole being an excessive value.

the content of Cr in the binder phase CrB may be greater than 0.4 mass % and less than 0.9 mass %.

When the content of Cr in the binder phase CrB is greater than 0.4 mass %, the effect of “Cr binds with N in the hard phase and thereby suppresses the solid solution of W into the hard phase” is more likely to be achieved. Meanwhile, when the content of Cr in the binder phase CrB is less than 0.9 mass %, a carbide of Cr is less likely to form in the binder phase.

Accordingly, the binder phase is less likely to become brittle, and thus fracture resistance improves easily.

As such, the cermet tool 1 in which the content of Cr in the binder phase CrB is greater than 0.4 mass % and less than 0.9 mass % can have suitably increased high-temperature strength and suitably improved fracture resistance.

The content of Cr in the binder phase CrB may be less than the content of Cr in the hard phase CrH. This is effective when, for example, the content of W in the hard phase WH is greater than the content of W in the binder phase WB. When the amount of WH is relatively small, the solid solution of W in the binder phase into the hard phase is greatly affected. In this case, a relatively large amount of CrH has a better effect of suppressing solid solution of W in the binder phase into the hard phase. When both the values of CrH and CrB are high, although the effect of suppressing the solid solution of W in the binder phase into the hard phase is good, a carbide of Cr tends to form in the binder phase as described above. When the amount of CrH is relatively large and the amount of CrB is relatively small, the effect of suppressing the formation of a carbide of Cr in the binder phase can be achieved easily while the effect of suppressing the solid solution of W in the binder phase into the hard phase is achieved.

The ratio of the content of Cr in the binder phase CrB to the content of Cr in the hard phase CrH, that is, CrB/CTH, may be greater than 0.33 and 1 or less. The cermet tool 1 in which CrB/CrH is in the above range has a good balance of properties, and also has high fracture resistance and high-temperature strength.

### Coating Layer 3

The base 2 is coated with the coating layer 3 for the purpose of, for example, improving the wear resistance and heat resistance of the base 2. Although FIG. 2 illustrates an example in which the coating layer 3 covers the entire surface of the base 2, the coating layer 3 does not necessarily need to cover the entire surface of the base 2. The coating layer 3 may be located on at least a portion of the surface of the base 2. When the coating layer 3 is located on a first surface (here, the upper surface) of the base 2, the first surface has high wear resistance and heat resistance. When the coating layer 3 is located on a second surface (here, a side surface) of the base 2, the second surface has high wear resistance and heat resistance.

The coating layer 3 may be composed of, for example, at least one metal element selected from the group consisting of Group 4A elements, Group 5A elements, and Group 6A elements of the periodic table as well as Al and Si, and at least one non-metal element selected from the group consisting of C, N, and O. With such a configuration, the coating layer 3 has improved oxidation resistance. This further improves the wear resistance of the coating layer 3. The coating layer 3 may be one layer. The cermet tool 1 may have a coating layer 3 made of layered layers.

Cutting Tool A configuration of a cutting tool provided with the cermet tool 1 described above will be described with reference to FIG. 7. FIG. 7 is a front view illustrating an example of a cutting tool according to the embodiment.

As illustrated in FIG. 7, a cutting tool 100 according to the embodiment includes the cermet tool 1 and a holder 70 for fixing the cermet tool 1.

The holder 70 is a rod-shaped member that extends from a first end (the upper end in FIG. 7) toward a second end (the lower end in FIG. 7). The holder 70 is made of, for example, steel or cast iron. Among these members, it is particularly preferable to use steel having high toughness.

The holder 70 includes a pocket 73 at an end portion on the first end side. The pocket 73 is a portion at which the cermet tool 1 is mounted. The pocket 73 has a seating surface intersecting the rotation direction of a workpiece and a restraint side surface inclined with respect to the seating surface. The seating surface is formed with a screw hole into which the screw 75 to be described below is screwed.

The cermet tool 1 is located in the pocket 73 of the holder 70 and is mounted on the holder 70 via the screw 75. That is, the screw 75 is inserted into the through hole 21 of the cermet tool 1, and the tip of the screw 75 is inserted into the screw hole formed in the seating surface of the pocket 73 with the screw portions screwed together. Thus, the cermet tool 1 is mounted on the holder 70 with the cutting edge portion protruding outward from the holder 70.

In the embodiment, a cutting tool used for so-called turning processing is described as an example. Examples of the turning processing include boring, external turning, and groove-forming. Note that, the cutting tool is not limited to a cutting tool used in turning processing. For example, the cermet tool 1 may be used as a cutting tool for milling processing. Examples of the cutting tool used for milling processing include a milling cutter such as a plain milling cutter, a face milling cutter, a side milling cutter, and a groove milling cutter, and an end mill such as a single-flute end mill, a multi-flute end mill, a taper-blade end mill, and a ball end mill.

### Manufacturing Method

A manufacturing method of the base 2 included in the cermet tool 1 will be explained.

First, a plurality of raw material powders are mixed to prepare a mixed powder. The raw material powders include TiCN powder, WC powder, CrC powder, at least one powder selected from the group consisting of carbide powders (excluding TiCN, WC and Cr₃C₂ powders), nitride powders, or carbonitride powders of Group 4, Group 5, or Group 6 metals in the periodic table, metal Co powder or metal Ni powder, and metal W powder and/or WC₁₋ₓ (0<x≤1) powder. If desired, the raw material powders may include carbon powder. The TiCN powder has an average particle diameter of from 0.1 μm to 1.2 μm, particularly from 0.3 μm to 0.9 μm. The WC powder has an average particle diameter of from 0.1 μm to 2.5 μm. The Cr₃C₂ powder has an average particle diameter of from 2 μm to 4 μm. The metal Co powder or the metal Ni powder has an average particle diameter of from 0.5 μm to 5 μm. The metal W powder and/or the WC₁₋ₓ (0<x≤1) powder has an average particle diameter of from 3 μm to 15 μm and a content of from 1 mass % to 20 mass %. A predetermined amount of MO₂C powder having an average particle diameter of from 0.5 μm to 5 μm may be further added to the mixed powder.

In the present embodiment, TiC powder, TiN powder, WC powder, NbC powder, MnCO₃ powder, TaC powder, VC powder, and ZIC powder having an average particle diameter of from 0.1 μm to 3 μm may be used as the at least one powder selected from the group consisting of carbide powders, nitride powders, or carbonitride powders of Group 4, Group 5, or Group 6 metals in the periodic table other than TiCN powder.

The mixed powder is prepared by adding a binder, a solvent, and the like to the raw material powders described above, and subjecting the raw material powders to a known mixing method such as ball milling, vibration milling, jet milling, or attritor milling. When the powders are mixed using attritor milling, the raw material powders are ground to a smaller particle diameter, but the metal powders have high ductility and therefore tend to be hard to grind. The mixed powder is then made into a powder compact having a predetermined shape by a known molding method such as press molding, extrusion molding, or injection molding.

Next, the above-described powder compact is fired in a vacuum or an inert gas atmosphere. In the present embodiment, firing under the following conditions allows for the production of a cermet having the predetermined composition described above. (a) First, degreasing is performed by raising the temperature from room temperature to 450° C. and holding the temperature at 450° C. for from 0.5 hour to 2 hours. (b) Subsequently, the temperature, which is at 450° C., is further raised to from 1000° C. to 1100° C. (c) Then, in a vacuum, the temperature is raised from the temperature that is from 1000° C. to 1100° C. to a firing temperature T1 that is from 1280° C. to 1380° C. at a rate of temperature rise a that is from 0.1° C./min to 2° C./min. (d) Next, in a vacuum or in an inert gas atmosphere of from 30 Pa to 20000 Pa, the temperature is raised from the firing temperature T1 to a firing temperature T2 that is from 1500° C. to 1600° C. at a rate of temperature rise b that is from 4° C./min to 15° C./min. (e) Subsequently, in a vacuum or in an inert gas atmosphere of from 30 Pa to 20000 Pa, the firing temperature T2 is held for from 0.5 hour to 2 hours. (f) Thereafter, in a vacuum or in an inert gas atmosphere of from 30 Pa to 20000 Pa, firing is performed under the firing condition in which the temperature is lowered at a rate of temperature decline e of from 5° C./min to 40° C./min.

### EXAMPLE

An example of the present disclosure will be specifically described below. The present disclosure is not limited to the following example.

A plurality of samples No. 1 to No. 10 each having a base made of a cermet sintered body were produced by the above-described manufacturing method. Among Samples No. 1 to No. 10, Samples No. 3 to No. 8 are examples of the present disclosure. Samples No. 1, No. 2, No. 9, and No. 10 are comparative examples.

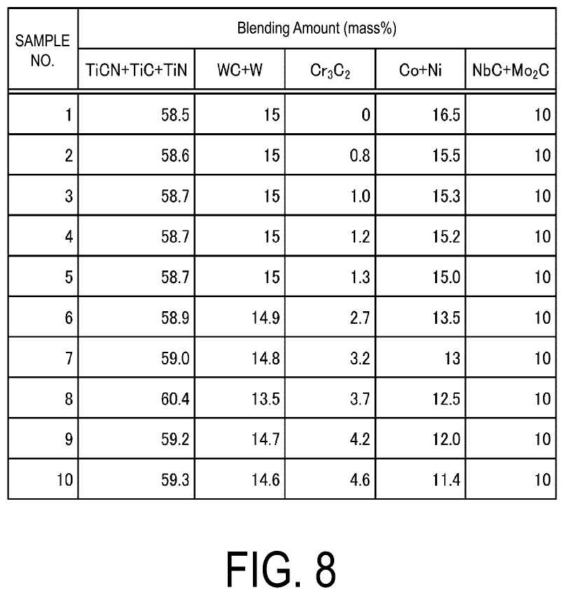

The blending amounts of various raw materials in each of Samples No. 1 to No. 10 are as presented in FIG. 8. FIG. 8 is a table presenting blending amounts of various raw materials in Samples No. 1 to No. 10.

As presented in FIG. 8, the smaller the sample number, the lower the content of Cr at the time of blending. That is, the content of Cr at the time of blending was the lowest in Sample No. 1 (0 mass % in terms of the content of Cr₃C₂) and the highest in Sample No. 10 (4.646 mass % in terms of the content of Cr₃C₂). The content of W at the time of blending, in terms of the content of WC and W, was the lowest at 13.495 mass % in Sample No. 8 and the highest at 15 mass % in Samples No. 1 to No. 5, but was substantially the same across Samples No. 1 to No. 10.

The produced samples No. 1 to No. 10 were subjected to a strength test. Each sample was made into a test piece having a shape of 3 mm×4 mm×40 mm. The test pieces were prepared by a press molding method, and the tension surface was mirror-finished. The strength test was performed using a three-point bending test fixture. The test speed (crosshead speed) was set to 0.5 mm/min, and the span (distance between external supporting points) was set to 30 mm. A load was applied until the test piece was broken, and the load at the time of breakage was taken as the strength of the sample.

The strength test was performed at room temperature (25° C.) and in air at 800° C.

The produced samples No. 1 to No. 10 were subjected to a cutting test. Specifically, Samples No. 1 to No. 10 were subjected to a fracture resistance test and a wear resistance test. In the fracture resistance test, the end surface of a workpiece was cut intermittently at a depth of cut of 0.5 mm, and the number of impacts causing a fracture in the sample was evaluated.

In the wear resistance test, the width (μm) of crater wear at 32 minutes of cutting was evaluated. The specific conditions for each test are as follows.

### Fracture Resistance Test

Workpiece: S45C
Cutting Speed: 150 m/min
Feed: 0.25 mm/rev
Depth of Cut: 0.5 mm
Cutting state: Wet
Evaluation Method: Number of impacts (times) until fracture

### Wear Resistance Test

Workpiece: SCM435
Cutting Speed: 250 m/min
Feed: 0.2 mm/rev
Depth of Cut: 1.0 mm
Cutting state: Wet
Evaluation Method: Width (μm) of crater wear at 32 minutes of cutting

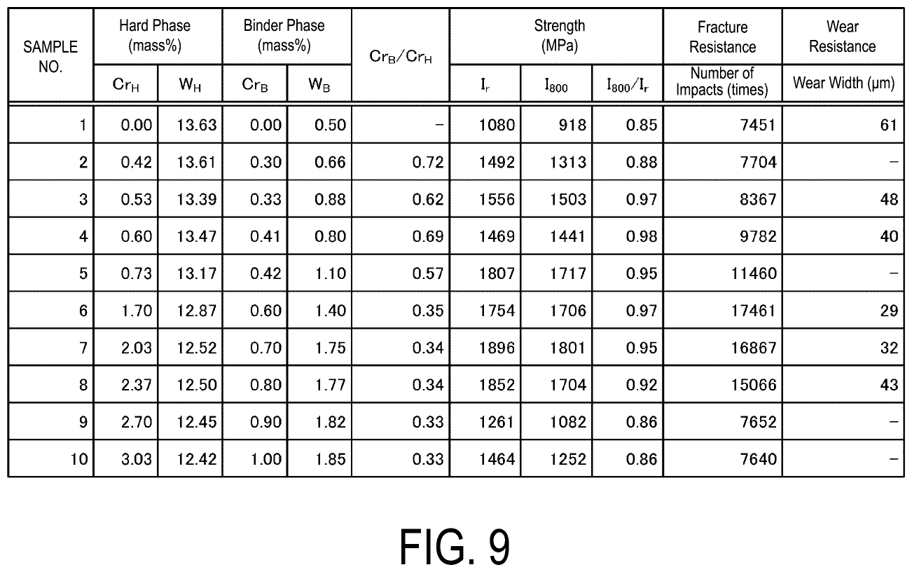

FIG. 9 is a table summarizing the results of various tests on Samples No. 1 to No. 10.

As presented in FIG. 9, in Sample No. 1, the content of Cr in the hard phase CrH and the content of Cr in the binder phase CrB were both 0 mass %. That is, the hard phase and the binder phase of Sample No. 1 do not contain Cr. In Sample No. 1, the content of W in the hard phase WH was 13.63 mass %, and the content of W in the binder phase WB was 0.5 mass %.

In Sample No. 2, the content of Cr in the hard phase CrH was 0.42 mass %, the content of W in the hard phase WH was 13.61 mass %, the content of Cr in the binder phase CrB was 0.3 mass %, and the content of W in the binder phase WB was 0.66 mass %. In Sample No. 2, CrB/CTH was 0.72.

In Sample No. 3, the content of Cr in the hard phase CrH was 0.53 mass %, the content of W in the hard phase WH was 13.39 mass %, the content of Cr in the binder phase CrB was 0.33 mass %, and the content of W in the binder phase WB was 0.88 mass %. In Sample No. 3, CrB/CrH was 0.62.

In Sample No. 4, the content of Cr in the hard phase CrH was 0.6 mass %, the content of W in the hard phase WH was 13.47 mass %, the content of Cr in the binder phase CrB was 0.41 mass %, and the content of W in the binder phase WB was 0.8 mass %. In Sample No. 4, CrB/CTH was 0.69.

In Sample No. 5, the content of Cr in the hard phase CrH was 0.73 mass %, the content of W in the hard phase WH was 13.17 mass %, the content of Cr in the binder phase CrB was 0.42 mass %, and the content of W in the binder phase WB was 1.1 mass %. In Sample No. 5, CrB/CTH was 0.57.

In Sample No. 6, the content of Cr in the hard phase CrH was 1.7 mass %, the content of W in the hard phase WH was 12.87 mass %, the content of Cr in the binder phase CrB was 0.6 mass %, and the content of W in the binder phase WB was 1.4 mass %. In Sample No. 6, CrB/CrH was 0.35.

In Sample No. 7, the content of Cr in the hard phase CrH was 2.03 mass %, the content of W in the hard phase WH was 12.52 mass %, the content of Cr in the binder phase CrB was 0.7 mass %, and the content of W in the binder phase WB was 1.75 mass %. In Sample No. 7, CrB/CrH was 0.34.

In Sample No. 8, the content of Cr in the hard phase CrH was 2.37 mass %, the content of W in the hard phase WH was 12.5 mass %, the content of Cr in the binder phase CrB was 0.8 mass %, and the content of W in the binder phase WB was 1.77 mass %. In Sample No. 8, CrB/CrH was 0.34.

In Sample No. 9, the content of Cr in the hard phase CrH was 2.7 mass %, the content of W in the hard phase WH was 12.45 mass %, the content of Cr in the binder phase CrB was 0.9 mass %, and the content of W in the binder phase WB was 1.82 mass %. In Sample No. 9, CrB/CH was 0.33. The presence of a Cr carbide in the binder phase was confirmed in Sample No. 9.

In Sample No. 10, the content of Cr in the hard phase CrH was 3.03 mass %, the content of W in the hard phase WH was 12.42 mass %, the content of Cr in the binder phase CrB was 1 mass %, and the content of W in the binder phase WB was 1.85 mass %. In Sample No. 10, CrB/CrH was 0.33. The presence of Cr carbide in the binder phase was confirmed in Sample No. 10.

It can be seen that as the content of Cr in the hard phase CrH increased, the content of W in the binder phase WB increased, and the content of W in the hard phase WH decreased. These results indicated the solid solution of W into the hard phase was suppressed by the presence of Cr.

In Samples No. 4 to No. 8, the content of Cr in the hard phase CrH was 0.6 mass % or greater and less than 2.5 mass %. In Samples No. 3 to No. 8, the content of W in the binder phase WB was 0.8 mass % or greater and less than 1.8 mass %. In Samples No. 4 to No. 8, the content of Cr in the binder phase CrB was greater than 0.4 mass % and less than 0.9 mass %. In Samples No. 3 to No. 8, the ratio of the content of Cr in the binder phase CrB to the content of Cr in the hard phase CrH, or CrB/CH, was greater than 0.33 and 1 or less.

The strength test result for Sample No. 3 indicated the strength at room temperature (hereinafter referred to as “room-temperature strength Iᵣ”) was 1556 MPa while the strength at 800° C. (hereinafter referred to as “high-temperature strength I₈₀₀”) was 1503 MPa. The ratio of the high-temperature strength I₈₀₀ to the room-temperature strength Iᵣ, that is, I₈₀₀/Iᵣ, was 0.97. The fracture resistance test result (number of impacts) of Sample No. 3 was 8367 times, and the wear resistance test result (width of crater wear) was 48 μm.

The strength test result for sample No. 4 indicated the room-temperature strength Iᵣ was 1469 MPa while the high-temperature strength I₈₀₀ was 1441 MPa, and I₈₀₀/Iᵣ was 0.98. The fracture resistance test result (number of impacts) of Sample No. 4 was 9782 times, and the wear resistance test result (width of crater wear) was 40 μm.

The strength test result for sample No. 5 indicated the room-temperature strength Iᵣ was 1807 MPa while the high-temperature strength I₈₀₀ was 1717 MPa, and I₈₀₀/Iᵣ was 0.95. The fracture resistance test result (number of impacts) of Sample No. 5 was 11460 times.

The strength test result for sample No. 6 indicated the room-temperature strength Iᵣ was 1754 MPa while the high-temperature strength I₈₀₀ was 1706 MPa, and I₈₀₀/Iᵣ was 0.97. The fracture resistance test result (number of impacts) of Sample No. 6 was 17461 times, and the wear resistance test result (width of crater wear) was 29 μm.

The strength test result for sample No. 7 indicated the room-temperature strength Iᵣ was 1896 MPa while the high-temperature strength I₈₀₀ was 1801 MPa, and I₈₀₀/Iᵣ was 0.95. The fracture resistance test result (number of impacts) of Sample No. 7 was 16867 times, and the wear resistance test result (width of crater wear) was 32 μm.

The strength test result for sample No. 8 indicated the room-temperature strength Iᵣ was 1852 MPa while the high-temperature strength I₈₀₀ was 1704 MPa, and I₈₀₀/Iᵣ was 0.92. The fracture resistance test result (number of impacts) of Sample No. 8 was 15066 times, and the wear resistance test result (width of crater wear) was 43 μm.

Next, test results of Samples No. 1, No. 2, No. 9, and No. 10 which are comparative examples will be described.

The strength test result for sample No. 1 indicated the room-temperature strength Iᵣ was 1080 MPa while the high-temperature strength I₈₀₀ was 918 MPa, and I₈₀₀/Iᵣ was 0.85. The fracture resistance test result (number of impacts) of Sample No. 1 was 7451 times, and the wear resistance test result (width of crater wear) was 61 μm.

The strength test result for sample No. 2 indicated the room-temperature strength Iᵣ was 1492 MPa while the high-temperature strength I₈₀₀ was 1313 MPa, and I₈₀₀/Iᵣ was 0.88. The fracture resistance test result (number of impacts) of Sample No. 2 was 7704 times.

The strength test result for sample No. 9 indicated the room-temperature strength Iᵣ was 1261 MPa while the high-temperature strength I₈₀₀ was 1082 MPa, and I₈₀₀/Iᵣ was 0.86. The fracture resistance test result (number of impacts) of Sample No. 9 was 7652 times.

The strength test result for sample No. 10 indicated the room-temperature strength Iᵣ was 1464 MPa while the high-temperature strength I₈₀₀ was 1252 MPa, and I₈₀₀/Iᵣ was 0.86. The fracture resistance test result (number of impacts) of Sample No. 10 was 7640 times.

In Samples No. 3 to No. 8 which are examples, the high-temperature strength I₈₀₀ was 1400 MPa or greater, and the ratio of the high-temperature strength I₈₀₀ to the room-temperature strength Iᵣ, that is, I₈₀₀/Iᵣ, was 0.9 or greater. With such characteristics, Samples No. 3 to No. 8 can cut a workpiece while maintaining high strength from room temperature to a high temperature. This is also apparent from the results of the fracture resistance test and the wear resistance test. That is, it can be seen that Samples No. 3 to No. 8, which are examples, all have higher fracture resistance and higher wear resistance than Samples No. 1, No. 2, No. 9, and No. 10, which are comparative examples. The content of Cr in the hard phase CrH in Samples No. 4 to No. 8 was in a range of 0.6 mass % or greater and less than 2.5 mass %, while the content of Cr in the hard phase CrH in Sample No. 3 was less than 0.6 mass %. Samples No. 4 to No. 8 had significantly higher fracture resistance and higher wear resistance than Sample No. 3. In particular, Sample No. 6 was superior to the other samples in both fracture resistance and wear resistance. The results indicate that, setting the content of Cr in the hard phase CrH to a range of greater than 0.8 mass % and less than 2 mass % can result in a cermet tool having particularly excellent fracture resistance and wear resistance.

As described above, the cermet tool according to the embodiment (as an example, the cermet tool 1) is a cermet tool having a base (as an example, the base 2) made of a cermet sintered body, the cermet sintered body containing a hard phase containing at least a carbonitride of Ti and a binder phase containing Co and/or Ni. The cermet tool according to the embodiment contains the hard phase and the binder phase, further contains Cr and W, and has a strength I₈₀₀ at 800° C. of 1400 MPa or greater, and the ratio of the strength I₈₀₀ to the strength Iᵣ at room temperature, that is, I₈₀₀/Iᵣ, of 0.9 or greater.

Therefore, the cermet tool according to the embodiment has great high-temperature strength and high resistance to thermal shock, and thus has excellent fracture resistance.

Note that the shape of the cermet tool 1 illustrated in FIG. 1 is merely an example and does not limit the shape of the cermet tool according to the present disclosure. The cermet tool according to the present disclosure may include a body having, for example, a rotation axis and a rod-like shape extending from a first end toward a second end, a cutting edge located at the first end of the body, and a groove extending in a spiral shape from the cutting edge toward the second end of the body.

Further effects and variations can be readily derived by those skilled in the art. Thus, a wide variety of aspects of the present invention are not limited to the specific details and representative embodiment represented and described above. Accordingly, various changes are possible without departing from the spirit or scope of the general inventive concepts defined by the appended claims and their equivalents.

1. A cermet tool comprising a base made of a cermet sintered body, the cermet sintered body comprising a hard phase comprising at least a carbonitride of Ti and a binder phase comprising Co and/or Ni, wherein
the cermet tool comprises the hard phase and the binder phase, further comprises Cr and W, and has a strength I800 at 800° C. of 1400 MPa or greater, and a ratio of the strength I800 to a strength Iᵣ at room temperature, that is, I800/Iᵣ, of 0.9 or greater.

2. The cermet tool according to claim 1, wherein
a content of Cr in the hard phase CrH is 0.6 mass % or greater and less than 2.5 mass %.

3. The cermet tool according to claim 1, wherein
a content of W in the hard phase WH is smaller than a content of W in the binder phase WB.

4. The cermet tool according to claim 1, wherein
a content of Cr in the binder phase CrB may be less than a content of Cr in the hard phase CrH.

5. The cermet tool according to claim 4, wherein
a ratio of the content of Cr in the binder phase CrB to the content of Cr in the hard phase CrH, that is, CrB/CrH, is greater than 0.33 and 1 or less.

6. The cermet tool according to claim 1, wherein
one or more coating layers are located on at least a part of a surface of the base, the one or more coating layers comprising at least one metal element selected from the group consisting of Group 4A elements, Group 5A elements, and Group 6A elements of the periodic table as well as Al and Si, and comprising at least one non-metal element selected from the group consisting of C, N, and O.

7. A cutting tool comprising
a holder extending from a first end toward a second end and comprising a pocket at the first end; and
the cermet tool according to claim 1, the cermet tool being located in the pocket.
